(19) United States
(12) Patent Application Publication
(10) Pub. No.: US 2007/0121345 A1
(43) Pub. Date: May 31, 2007

(54) Bottom-lighting type backlight module

(75) Inventors: Shao-Han Chang, Tu-cheng (TW); Li-Zhou Shi, Shenzhen (CN); Hua-Dong Zou, Shenzhen (CN); Yu-Ya Liu, Shenzhen (CN)

Correspondence Address: MORRIS MANNING MARTIN LLP, 3343 PEACHTREE ROAD, NE, 1600 ATLANTA FINANCIAL CENTER, ATLANTA, GA, 30326, US

(73) Assignee: HON HAI Precision Industry CO., LTD., Tu-Cheng City (TW)

(21) Appl. No.: 11/502,217

(22) Filed: Aug. 10, 2006

(30) Foreign Application Priority Data
Nov. 25, 2005 (CN) 200510101799.4

(51) Int. Cl. F21V 7/04

(52) U.S. Cl. 362/633

(57) ABSTRACT

A bottom-lighting type backlight module includes a frame, a light guide member and a plurality of linear light sources. The frame includes a base and a plurality of sidewalls extending from the periphery of the base to define an opening. The light guide member is disposed on the opening of the frame, the light guide member having a prism surface away from the base of the frame. The light sources are arranged in the frame under the light guide member. The base of the frame defines a plurality of projections extending out from thereof towards the opening along a direction perpendicular to the light sources, and a plurality of curving surfaces are defined by the base of the frame between two adjacent projections, each curving surface facing the adjacent light source. The present backlight module may have good optical uniformity and high brightness without the help of light diffusion plate.

### 1. TECHNICAL FIELD

The present invention relates to a bottom-lighting type backlight module for use in, for example, a liquid crystal display (LCD).

### 2. BACKGROUND

In a liquid crystal display device, liquid crystal is a substance that does not itself illuminate light. Instead, the liquid crystal relies on reflecting light from a light source, thereby displaying images and data. In the case of a typical liquid crystal display device, a backlight module powered by electricity supplies the needed light.

Typically, there are two types of backlight systems: an edge lighting type and a bottom-lighting type. The edge-lighting type of backlight system is widely used in small and medium size liquid crystal display for merits on small weight, thin body and low energy cost. Large size liquid crystal display seldom uses the edge-lighting backlight system because the results based on the merits mentioned above is poor. Furthermore, the large size edge-lighting type backlight system seldom satisfies the requirement of light brightness and optical uniformity. Nowadays, the market demand for larger size liquid crystal display has increased progressively. Therefore, the bottom-lighting type of backlight system needs to be developed to satisfy the market demand.

Referring to FIGS. 5 and 6, a typical bottom-lighting backlight module 10 is shown. The backlight module 10 includes a frame 11, a reflective plate 12, a number of cold cathode fluorescent lamps 13, a light diffusion plate 14, a first light diffusion sheet 15, a prim sheet 16, and a second light diffusion plate 17. The frame 11 is a rectangular housing, which includes a base 111 and a plurality of sidewalls 112 extending from the periphery of the base to define an opening (not labeled). The reflective plate 12 is disposed on the base 111 of the frame 11. The light diffusion plate 14, the first light diffusion sheet 15, the prim sheet 16 and the second light diffusion sheet 17 are stacked on the opening of the frame 11 in order. The cold cathode fluorescent lamps 13 are positioned in the frame 11 under the light diffusion plate 14. A thickness of the light diffusion plate 14 is in a range of about 2 to 3 centimeters, and is much larger than both that of the first and second light diffusion sheet 15 and 17. Therefore, the light beams emitted from the cold cathode fluorescent lamps 13 are substantially diffused in the light diffusion plate 14, and finally surface light beams are output from the second light diffusion sheet 17. It is noted that the light diffusion plate 14 is significantly needed to improve the backlight module 10's optical uniformity.

However, the light diffusion plate 14 is typically manufactured by uniformly dispersing a plurality of light diffusion particles 142 into transparent resin matrix materials 141. The light diffusion particles 142 may be selected from a group comprising of silicon dioxide (SiO₂) particles and titanium dioxide (TiO₂) particles. Because the light beams are diffused at the light diffusion particles 142 many times in the light diffusion plate 14, a part of the light energy would have been consumed in the light beam's diffusing process, thus a light brightness of the backlight module is decreased. In addition, the light diffusion plate 14 costs much in manufacturing the backlight module 10.

What is needed, therefore, is a bottom-lighting type backlight module that overcome the above mentioned disadvantage.

### SUMMARY

A bottom-lighting type backlight module according to a preferred embodiment includes a frame, a light guide member and a plurality of linear light sources. The light guide member includes a light incident surface and an opposite light emitting surface facing away from the light incident surface. The frame includes a base facing toward and spaced from the light incident surface of the light guide member, and a plurality of elongated projections formed on the base, every two adjacent projections and the base cooperatively defining an elongated groove therebetween. The linear light sources are arranged between the light guide member and the frame with each light source received in a corresponding one of the grooves.

Other advantages and novel features will become more apparent from the following detailed description of the preferred embodiments, when taken in conjunction with the accompanying drawings.

### BRIEF DESCRIPTION OF THE DRAWINGS

Many aspects of the bottom-lighting backlight module can be better understood with reference to the following drawings. The components in the drawings are not necessarily to scale, the emphasis instead being placed upon clearly illustrating the principles of the present backlight module. Moreover, in the drawings, like reference numerals designate corresponding parts throughout the several views.

FIG. 1 is a schematic, perspective view of a bottom-lighting type backlight module according to a first preferred embodiment;

FIG. 2 is a schematic, cross-sectional view of the bottom-lighting type backlight module taken along a line II-II of FIG. 1;

FIG. 3 is a partially enlarged, cross-sectional view of the bottom-lighting type backlight module of FIG. 1 and showing light beams reflected and refracted therein;

FIG. 4 is a schematic, cross-sectional view of a bottom-lighting type backlight module according to a second preferred embodiment;

FIG. 5 is a schematic, cross-sectional view of a conventional bottom-lighting type backlight module; and

FIG. 6 is a schematic, partially enlarged cross-sectional view of a diffusing plate of the bottom-lighting type backlight module of FIG. 5.

### DETAILED DESCRIPTION OF THE PREFERRED EMBODIMENTS

Reference will now be made to the drawings to describe preferred embodiments of the present bottom-lighting backlight module, in detail.

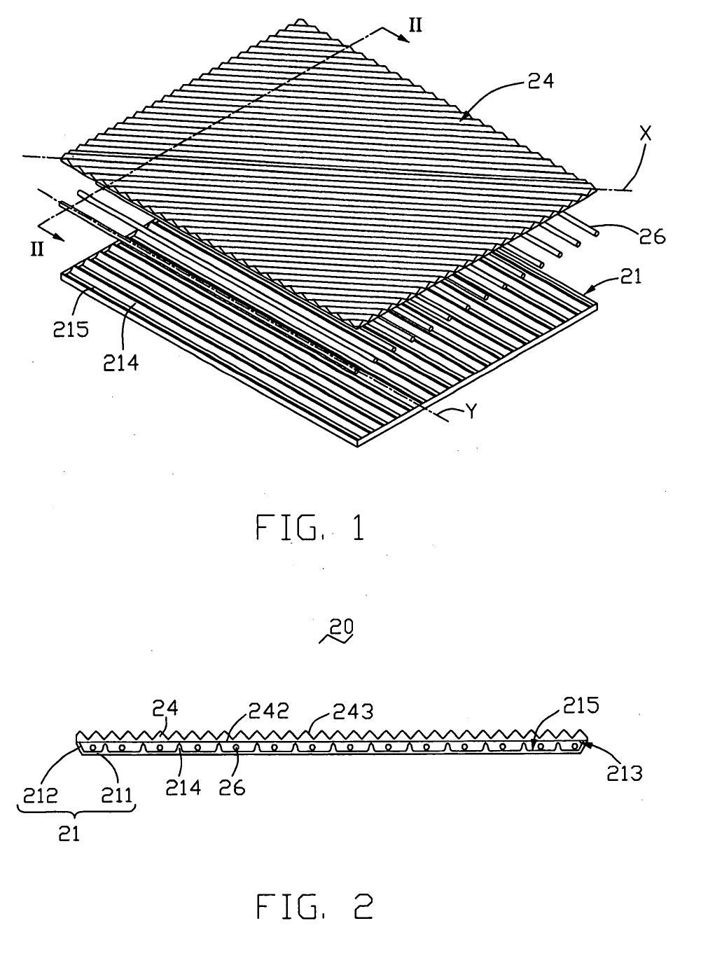

Referring to FIGS. 1 through 3, a bottom-lighting type backlight module 20 in accordance with a first preferred embodiment is shown. The backlight module 20 includes a frame 21, a light guide member 24, and a plurality of linear light sources 26. The frame 21 includes a base 211 and a plurality of sidewalls 212 extending from the periphery of the base 211 to define an opening 213. The light guide member 24 is disposed on the opening 213 of the frame 21. The linear light sources 26 are arranged in the frame 21 along a Y direction, under the light guide member 24. The base 211 of the frame 21 defines a plurality of projections 214 extending out therefrom towards the opening 213 along the Y direction parallel to the linear light sources 26.

Each projection 214 is an elongated rod having two side surfaces (not labeled). The side surfaces may be configured to be either a flat surface or a curving surface. In the embodiment, the side surface of each projection 214 is the curving surface. Curving surfaces of the two adjacent projections 214 and the base 211 cooperatively define a plurality of elongated grooves 215 arranged side by side. Each groove 215 receives a corresponding linear light source 26 therein.

The light guide member 24 is a rectangular sheet, which includes a flat surface 242 facing the frame 21 and a prism surface 243 opposite to the flat surface 242. The prism surface 243 defines a plurality of prism structures (not labeled) thereon. The prism structures each extend along an X-direction and are configured to be parallel (or at least essentially parallel) to each other. An angle between the X direction with respect to the Y direction is configured to be in a range from about 10 to about 80 degrees. A shape of each prism structure may be selected from an elongated V-shaped protrusion or an elongated semi-circular protrusion. In this embodiment, each prism structure is configured to be an elongated V-shaped protrusion. It is also said that the angle is defined by an axis of the elongated side of the prism structure with respect to an axis of the linear light source 26.

The light guide member 24 may be selected from one of a prism sheet and a transparent plate having a prism surface. A material of the light guide member 24 may be formed of transparent resin materials, such as polymethyl methacrylate (PMMA), polycarbonate (PC), and a combination thereof.

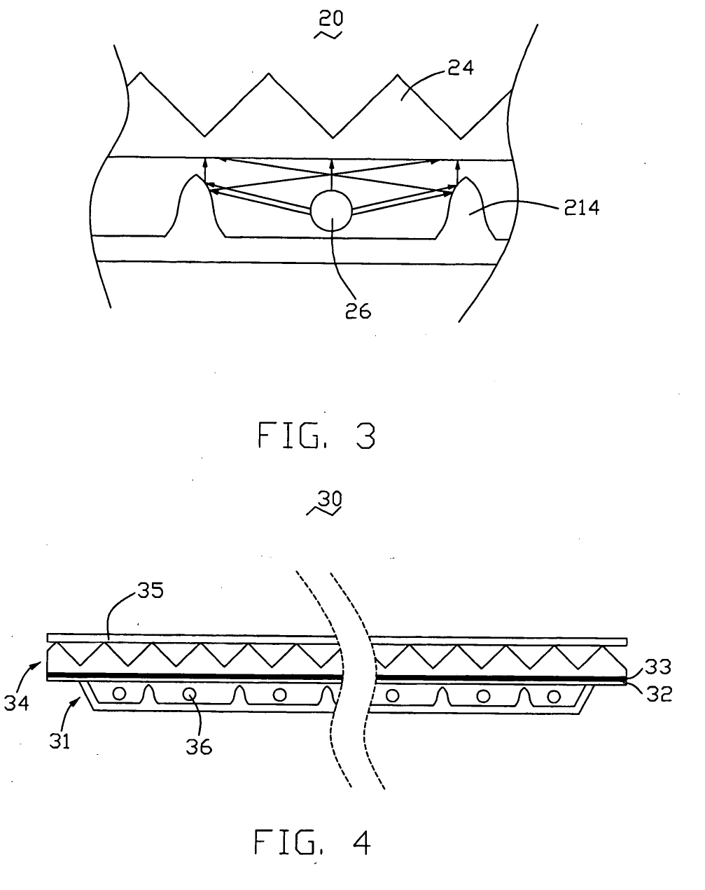

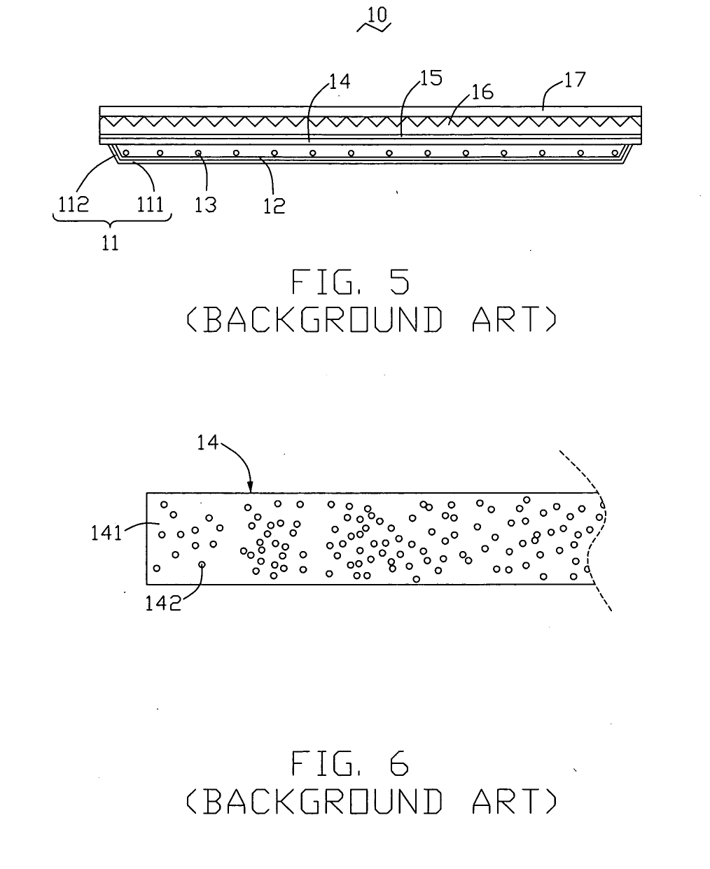

Also referring to FIG. 3, in use, not only will the light guide member 24 directly above the linear light sources 26 have more incidence of light and illumination, other portions of the light guide member 24 above the left and right sides of the corresponding light sources 26 will also have more incidence of light and illumination because more light rays are reflected by the curving surface of elongated grooves 215 facing corresponding linear light sources 26. With the help of the light guide member 24 (i.e. the prism structures and the angle defined by an axis of the elongated side of the prism structure with respect to an axis of the linear light source 26 is configured to be in the range from about 10 to about 80 degrees), a part of light rays that incident at a portion of the light guide member 24 above the linear light sources 26, would be total reflected at the prism surface 243, thus, illumination of the portion of the light guide member 24 above the linear light sources 26 is decreased. In addition, light emitting angles of a plurality of light rays that incident at other portions of the light guide member 24 above the left and right sides of the corresponding light sources 26, would be decreased for reducing reflection and increasing the illumination of the other portions of the light guide member 24. Therefore, a uniform and high brightness optical performance of the backlight module 20 is obtained without the help of a conventional light diffusion plate, so as to decrease the cost of the backlight module 20.

Referring to FIG. 4, a bottom-lighting type backlight module 30 in accordance with a second preferred embodiment is shown. The backlight module 30 includes a frame 31, a light guide member 34, and a plurality of linear light sources 36. The backlight module 30 is similar in principle to the backlight module 20, except that the backlight module 30 further includes a transparent supporting plate 32, a light diffusion film 33 and a reflecting polarizer sheet 35.

The transparent supporting plate 32 is positioned on the opening of the frame 31 under the light guide member 34, so as to support the light guide member 34. The light diffusion film 33 is disposed between the light guide member 34 and the transparent supporting plate 32. The light diffusion film 33 not only may be formed on an upper surface of the transparent supporting plate 32, but also may be formed on a flat surface of the light guide member 34 adjacent to the transparent supporting plate 32. Compared with the typical light diffusion plate, a thickness of the light diffusion film 33 is smaller, thus few light energy would be lost when the light passes through the light diffusion film 33 and a more uniform optical performance would be obtained. The reflecting polarizer sheet 35 is positioned on the light guide member 34 for further improving light brightness of the backlight module 30.

A material of the transparent supporting plate 32 may be selected from a group comprising of glass and transparent resin materials. The light diffusion film 33 may be manufactured by depositing an oil ink film having a plurality of diffusion particles on the upper surface of the transparent supporting plate 32 or on the flat surface of the light guide member 34. Alternatively, the light diffusion film 33 and the transparent supporting plate 32 may be integrally formed by etching a plurality of microstructures having light diffusion capability on the upper surface of the transparent supporting plate 32.

Finally, while the present invention has been described with reference to particular embodiments, the description is illustrative of the invention and is not to be construed as limiting the invention. Therefore, various modifications can be made to the embodiments by those skilled in the art without departing from the true spirit and scope of the invention as defined by the appended claims.

What is claimed is:

1. A bottom-lighting type backlight module comprising:
a frame having a base and a plurality of sidewalls extending from the periphery of the base to define an opening;
a light guide member disposed on the opening the frame, the light guide member having a prism surface atop the base of the frame;
a plurality of linear light sources arranged in the frame under the light guide member;
wherein the base defines a plurality of projections extending out from thereof toward the opening along a direction parallel to the light sources, and a plurality of curving surfaces are defined by the base of the frame and two adjacent projections, each curving surface facing the adjacent light source.

2. The backlight module according to claim 1, wherein the prism surface defines a plurality of prism structures thereon.

3. The backlight module according to claim 2, wherein a shape of each prism structure may be selected from an elongate V-shaped protrusion or an elongate semi-circular protrusion.

4. The backlight module according to claim 3, wherein a angle is defined by an axis of the elongated edge of the prism structure with respect to an axis of the linear light source, and the angle is configured to be in a range from about 10 degrees to about 80 degrees.

5. The backlight module according to claim 1, wherein the linear light source is cold cathode fluorescent lamp.

6. The backlight module according to claim 1, wherein the light guide member may be selected from one of a prism sheet and a transparent plate having a prism surface.

7. The backlight module according to claim 1, wherein a material of the light guide member may be selected from a group comprising of polymethyl methacrylate, polycarbonate, and the other suitable transparent resin materials.

8. The backlight module according to claim 1, further comprising a transparent supporting plate disposed on the opening of the frame under the light guide member.

9. The backlight module according to claim 8, wherein a material of the transparent supporting plate is selected from a group comprising of glass and transparent resin materials.

10. The backlight module according to claim 8, further comprising a light diffusion film formed on a flat surface that is opposite to the prism surface of the light guide member.

11. The backlight module according to claim 8, further comprising a light diffusion film formed on an upper surface of the transparent supporting plate.

12. The backlight module according to claim 11, wherein the light diffusion film is manufactured by depositing an oil ink film having a plurality of diffusion particles on the upper surface of the transparent supporting plate or on the flat surface of the light guide member.

13. The backlight module according to claim 11, wherein the light diffusion film and the transparent supporting plate is integrally formed by etching a plurality of microstructures having light diffusion capability on the upper surface of the transparent supporting plate.

14. The backlight module according to claim 1, further comprising a reflecting polarizer plate disposed on the light guide member.

15. A backlight module comprising:
a light guide member having a light incident surface and an opposite light emitting surface facing away from the light incident surface;
a frame including a base facing toward and spaced from the light incident surface of the light guide member, and a plurality of elongated projections formed on the base, every two adjacent projections and the base cooperatively defining an elongated groove therebetween; and
a plurality of linear light sources arranged between the light guide member and the frame with each light source received in a corresponding one of the grooves.

16. The backlight module of claim 15, wherein the light incident surface is flat, and the light emitting surface forms a plurality of parallel prism lenses.

17. The backlight module of claim 15, wherein each of the projections includes two side surfaces each located at one of two adjacent grooves, and each side surface is oriented in a manner so as to reflect light emitted by a corresponding light source toward the light incident surface.

18. A backlight module comprising:
a light guide member having a light incident surface and an opposite light emitting surface facing away from the light incident surface;
a frame including a base facing toward and spaced from the light incident surface of the light guide member;
a plurality of light sources arranged between the light guide member and the frame; and
a projection extending from the base adjacent each of the light sources, the projection including a reflective surface configured for reflecting light emitted by a corresponding light source toward the light incident surface.

19. The backlight module of claim 18, wherein the reflect surface is an inclined surface.

20. The backlight module of claim 19, wherein the reflective surface is one of a flat surface and a curved surface.
